(19) United States
(12) Patent Application Publication
(10) Pub. No.: US 2026/0218871 A1
(43) Pub. Date: Jul. 30, 2026

(54) LUMINOUS MODULE AND AUTOMOTIVE LUMINOUS DEVICE

(71) Applicant: VALEO VISION, Bobigny (FR)

(72) Inventors: Pedro-Jose QUESADA, Bobigny (FR); Maria Josefa CRIADO TORRES, Bobigny (FR)

(73) Assignee: VALEO VISION, Bobigny (FR)

(21) Appl. No.: 19/145,659

(22) PCT Filed: Dec. 20, 2023
(86) PCT No.: PCT/EP2023/087158

§ 371 Date: Jul. 3, 2025

(30) Foreign Application Priority Data
Jan. 3, 2023 (EP) 23150217.0

(51) Int. Cl. F21S 41/148; F21S 41/153; F21S 41/19; F21S 41/32; F21S 41/39; F21S 41/663; F21S 45/47; F21S 45/49

(52) U.S. Cl. CPC F21S 41/148; F21S 41/153; F21S 41/192; F21S 41/321; F21S 41/39; F21S 41/663; F21S 45/47; F21S 45/49

(57) ABSTRACT

The present invention refers to an automotive luminous module. The automotive luminous module includes a first substrate including a first light source coupled with a first optical element, and a heatsink arranged in thermal communication with the first substrate. The first optical element includes a main attachment element configured to attach the first optical element to the heatsink without crossing the first substrate, and wherein the first substrate is retained between at least a portion of the first optical element and a portion of the heatsink.

### TECHNICAL FIELD

This invention is related to the field of automotive lighting devices, and more particularly, to the assembly of the different components comprised therein.

### BACKGROUND OF THE INVENTION

Automotive lighting devices require an increasing amount of electric connections, which are intended to provide control and power supply to the light sources contained therein

Further, heat dissipation elements also play a crucial role in the operation of these devices. The performance of solid-state light sources, such as light emitting diodes (LEDs) is heavily affected by temperature, so a good heat evacuation is advantageous for the performance of the light devices.

These heatsinks are arranged in thermal contact with the different printed circuit boards. These assemblies also comprise the printed circuit boards and the reflectors. The joint between all these elements must ensure mechanical stability and an accurate relative position of all these elements.

The joint operation usually comprises performing through holes in the printed circuit boards, to use bolts that secure the different elements.

However, it is not always possible to perform these through holes in the printed circuit boards, due to the lack of space in modern designs.

New solutions and designs are therefore sought to solve this problem.

### SUMMARY OF THE INVENTION

The invention provides a solution for this problem by luminous module for an automotive luminous device. This luminous module comprises:
a first substrate comprising a first light source configured to emit light;
a first optical element arranged to receive emitted light from the first light source and project the light; and
a heatsink arranged in thermal communication with the first substrate, the heatsink being configured to dissipate heat from the first substrate;
the luminous module being characterized in that
the first optical element comprises a main attachment element configured to attach the first optical element to the heatsink without crossing the first substrate; and in that
the substrate is retained between at least a portion of the first optical element and a portion of the heatsink.

Notably, the heatsink can comprise a plurality of fins.

As above-mentioned, the main attachment element is configured to attach the first optical element to the heatsink without crossing the first substrate. In other words, the main attachment element does not go through the first substrate. Therefore, the main attachment element does not interfere with the corresponding first substrate, which avoids adding mechanical stress on the first substrate.

An optical element is an element that has some optical properties to receive a light beam and emit it in a certain direction and/or shape, as a person skilled in automotive lighting would construe without any additional burden. Reflectors, collimators, light guides, projection lenses, etc., or the combination thereof are some examples of these optical elements which are useful for transforming the light beams emitted by the light source into an acceptable light pattern for the functionality chosen for the lighting device.

These optical elements can define a focus or a focus line, which is the point or the line where the light emitted by the light source is most effectively transmitted by the optical element.

With such an arrangement, the elements comprised in the luminous module (i.a., the substrate, the optical element and the heatsink) are solidly attached but without performing additional through holes in the substrates.

In some particular embodiments, a portion of the heatsink forms a portion of a frame for the first substrate.

This means that the material of the heatsink surrounds a portion of the first substrate also in the substrate plane, around at least a portion of the edge of the first substrate.

In some particular embodiments, the main attachment element comprises a fixing portion and is joined to the rest of the reflector part by means of an arm. In some particular embodiments, the fixing portion is attached to the heatsink.

The fixing portion is intended to form or receive an adequate fixation element, such as a screw or a bolt, and the joint by means of an arm is due to the fact that the joint is far from the rest of the reflector element. Thus, to save material, an arm is enough to transmit the retention force caused by this joint. In other embodiments, other type of fixation is possible, e.g., by means of a clipping hook.

In some particular embodiments, the first optical element is a reflector comprising a first reflection portion with a first reflection surface that reflects the light rays emitted by the first light source and defines the front of the first reflection surface.

In some particular embodiments, the arm is arranged on the first optical element at the rear of the first reflection portion and extending at the rear and away from the first reflection portion.

The front portion is defined by the emission of light, so the rear portion is the portion opposite to the front portion. In any case, the skilled person knows how to distinguish the front portion and the rear portion in a luminous module as the one of the invention.

Since the arm extends at the rear and away from the first reflection portion, the attachment of the first optical element does not interfere with the corresponding first substrate.

The first substrate can be an electronic substrate, such as an electronic circuit board.

In some particular embodiments, the luminous module further comprises
a second substrate comprising a second light source configured to emit light;
a second optical element arranged to receive emitted light from the second light source and project the light;
the main attachment element is arranged to further attach the first optical element to the second optical element without being in the path of rays emitted by the second light source and deviated by the second optical element.

In some particular embodiments, the luminous module further comprises at least one auxiliary attachment element configured to attach the first optical element with the second optical element, retaining the heatsink, the first substrate and the second substrate between a portion of the first optical element and a portion of the second optical element.

The light module when having the second substrate and second optical element has above mentioned, can have two different functionalities, performed by light sources located in different substrates and emitting light to different optical elements. This embodiment is more complex, so the invention is even more advantageous, since it does not disturb the complexity of the arrangement between these elements.

In some particular embodiments, the second optical element is a reflector comprising a second reflection portion with a second reflection surface that reflects the light rays emitted by the second light source and defines the front of the second reflection surface.

In some particular embodiments, the arm extends such that it is in a longitudinal direction at the level of the rear of the second reflection portion, such that the said fixing portion is attached to the second optical element at the rear of the second reflection portion. So considering a longitudinal direction, notably corresponding to the main direction of the beam by the luminous module, the arm is extended sufficiently away from the first reflection portion so that the arm is attached to the second optical element at the rear of the second reflection portion, i.e. behind the reflection portion.

In some particular embodiments, the second substrate is arranged in a plane parallel to the substrate plane. This parallel arrangement is easier for light projection and cooperation between the light sources of the two different substrates.

In some particular embodiments, the luminous module further comprises a further attachment element configured to attach the second optical element to the heatsink.

As said before, the operation with two substrates is more complex, and it is sometimes advisable to create partial attachments, such as this one, where the second optical element is attached to the heatsink.

In some particular embodiments, at least one auxiliary attachment element passes through a hole of the first substrate and/or through a hole of the second substrate.

The invention is also compatible with the fact that some auxiliary attachment elements pass through a hole in any of the substrates. This mixture boosts the possibilities for the designer to fit the different elements in the required space.

In some particular embodiments, none of the auxiliary attachment element passes through a hole of any of the substrates. Despite the compatibility of the invention with the through holes, as defined above, there is also the possibility that all the joints are performed outside the projection of the substrate, and therefore, without crossing them.

In some particular embodiments, the second substrate is arranged in a plane parallel to the substrate plane, but the projection of the second substrate over the first substrate according to a direction perpendicular to the plane of the first substrate has at least a portion which does not coincide with the first substrate.

This offset may be useful for optical reasons. For example, when the focal arrangement of one side needs different locations from the one of the other side and can also be advantageously used to place the attachments wisely not to disturb the rest of the elements.

In some particular embodiments, the second optical element is arranged such that the second reflection portion is at least partially offset at the rear compared to the said first reflection portion.

In such a case the invention is particularly advantageous, since the two reflectors may be attached together despite this offset and without interfering with the second reflection portion or with the rays reflected thereby. If this invention was not used, fixing the first reflector directly on the second reflector would generate a risk of having some deformation of the second reflecting surface. This risk is avoided by the present invention.

This has also the advantage that when the optical elements present a focal length, the second optical element can present a focal length much longer, which can be notably advantageous when the second optical element is coupled with second light sources to generate a segmented beam.

In some particular embodiments, the light source is a solid-state light source, such as a light emitting diode.

The term “solid state” refers to light emitted by solid-state electroluminescence, which uses semiconductors to convert electricity into light. Compared to incandescent lighting, solid state lighting creates visible light with reduced heat generation and less energy dissipation. The typically small mass of a solid-state electronic lighting device provides for greater resistance to shock and vibration compared to brittle glass tubes/bulbs and long, thin filament wires. They also eliminate filament evaporation, potentially increasing the lifespan of the illumination device. Some examples of these types of lighting comprise semiconductor light-emitting diodes (LEDs), organic light-emitting diodes (OLED), or polymer light-emitting diodes (PLED) as sources of illumination rather than electrical filaments, plasma or gas.

In some particular embodiments, the main attachment element has a triangular shape. This enables a good compromise between mechanical resistance and light weight.

In some particular embodiments, the main attachment element has stiffening ribs. This also enables a good compromise between mechanical resistance and light weight.

In some particular embodiments, the main attachment element is comprised between two fins of the heatsink. The location of the main attachment element between two fins of the heatsink enables the offset fixation of first optical element while enabling more heat exchange surface, as the fins extend on each side of the main attachment element.

In a further inventive aspect, the invention refers to a headlamp comprising a luminous module according to the first inventive aspect.

In some particular embodiments, the light sources are light emitting diodes and the second substrate is configured to provide a matrix beam functionality.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

### BRIEF DESCRIPTION OF DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1 shows some elements of a first embodiment of an automotive lighting device according to the invention.

FIG. 2 and FIG. 3 show respectively a transversal cut and a longitudinal cut in the light module of FIG. 1 to show the internal elements of this luminous module

FIG. 4 shows a headlamp which comprises a light module according to the previous figures.

In these figures, the following reference numbers have been used:
1 Luminous module
2 First printed circuit board
3 LED of the first printed circuit board
4 First reflector assembly
5 Heatsink
6 Main attachment element
7 Fixing portion of the main attachment element
8 Arm of the main attachment element
9 Second printed circuit board
10 Headlamp
11 LED of the second printed circuit board
12 Second reflector assembly
13 First auxiliary attachment element
14 Second auxiliary attachment element
15 Projection lens assembly
21 First reflection portion
22 Second reflection portion
100 Automotive vehicle

### DETAILED DESCRIPTION OF THE INVENTION

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

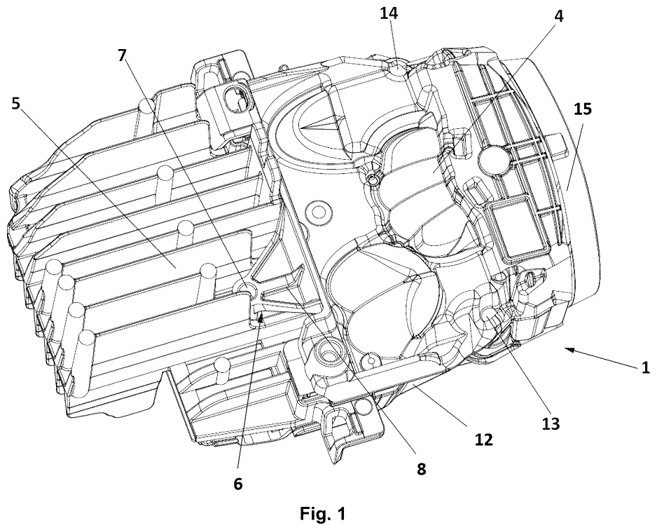

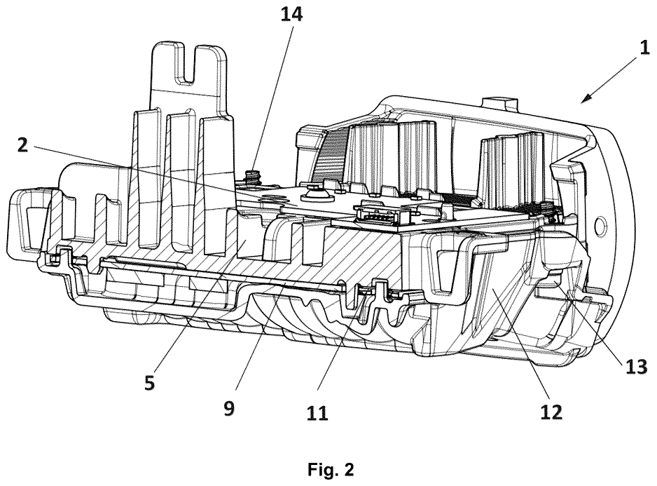

FIG. 1 shows a general perspective view of a luminous module according to the invention. FIG. 2 and FIG. 3 show respectively a transversal cut and a longitudinal cut in the light module of FIG. 1.

In this module 1, the following elements are seen: a first optical element, here a first reflector assembly 4, a heatsink 5, a second optical element, here a second reflector assembly 12, and a projection lens assembly 15.

The light module 1 also comprises printed circuit boards and LEDs, which emit light that is projected by the reflectors comprised in each of the first and second reflector assemblies 4, 12. However, the reflector assemblies 4, 12 hide these further elements, which will be shown in other figures. The first reflector assembly 4 comprises a first reflector portion 21 with a first reflection surface that reflects the light rays emitted by a first group of LEDs 3 of a first printed circuit board 2 and defines the front of the first reflector assembly 4. In turn, the second reflector assembly 12 comprises a second reflector portion 22 with a second reflection surface that reflects the light rays emitted by a second group of LEDs 11 and also defines the front of the second reflector assembly 12.

In FIGS. 1 and 3, it is relevant the way of attaching the first reflector assembly 4 to the rest of the elements of the light module 1.

The first reflector assembly 4 comprises a main attachment element 6 configured to attach the first reflector assembly 4 to the heatsink 5 without crossing the first printed circuit board. This is made by means of an arm 8 which joins the main attachment element 6 with the rest of the first reflector assembly 4, thus ensuring mechanical stability of the joint. This main attachment element 6 comprises a fixing portion 7, which is adequate to receive a bolt, that will provide the joint.

As can be seen from FIGS. 1 and 3, the main attachment element 6 is arranged to further attach the first reflector assembly 4 to the second reflector assembly 12 without being in the path of rays emitted by the second group of LEDs 11 and deviated by the second reflector portion 22.

The first reflector assembly 4 further comprises another two auxiliary attachment elements 13, 14 which joins the first reflector assembly 4 with the heatsink 5. In this case, however, the joints are performed using two through holes in the first printed circuit board.

As may be seen in this figure, in this example, the main attachment element 6 has a triangular shape, with a base starting from the first reflector assembly 4 and the vertex being located in the fixing portion 7. This main attachment also has stiffening ribs, which maintain good mechanical properties without increasing weight.

It can also be seen that this main attachment element 6 is housed between fins of the heatsink. This means that the main attachment element invades the heatsink zone, exiting from the reflector zone.

FIGS. 2 and 3 show the internal elements of this luminous module 1.

More particularly, the internal printed circuit boards are seen. Firstly, a first printed circuit board 2 comprises a plurality of LEDs 3, which forms the first group of LEDs. These LEDs 3 emit light which is projected by the plurality of reflectors of the first reflection portion 21 comprised in the first reflector assembly 4. The heatsink 5 is configured to dissipate heat from the first printed circuit board 2.

In this example, the plurality of LEDs 3 are in charge of providing, together with the first reflector assembly 4 and the projection lens assembly 15, a low beam functionality.

This first printed circuit board 2 is crossed by the two auxiliary attachment elements 13, 14, which attach the first reflector assembly (not shown in FIG. 2) to the heatsink 5 but is not crossed by the main attachment element 6 (not shown in FIG. 2). Here, this main attachment element 6 also attaches the first reflector assembly 4 to the heatsink 5, but without falling in the projection of the first printed circuit board 2. In this attachment process, the first printed circuit board 2 is retained between at least a portion of the first reflector assembly 4 and a portion of the heatsink 5.

In these FIGS. 2 and 3, a second printed circuit board 9 and a second reflector assembly 12 are also seen. This second printed circuit board 9 also comprises a group of LEDs 11, which are in this example in charge of providing, together with the second reflection portion 22 of the second reflector assembly 12 and the projection lens assembly 15, a matrix beam functionality.

As can be seen in FIG. 2, in this example, the auxiliary attachment elements 13, 14 attach the first optical element 4 not only to the heatsink 5, but also to the second reflector assembly 12, retaining the heatsink 5, the first printed circuit board 2 and the second printed circuit board 9 between a portion of the first reflector assembly 4 and a portion of the second reflector assembly 12.

Furthermore, although not seen in this figure, the second reflector assembly 12 also comprises a further attachment element configured to attach the second reflector assembly 12 to the heatsink 5.

The second reflector assembly 12 is arranged such that the second reflection portion 22 is at least partially offset at the rear compared to the said first reflection portion 21. Thanks to the invention, the two reflectors may be attached together despite this offset and without interfering with the second reflection portion 22 or with the rays reflected thereby.

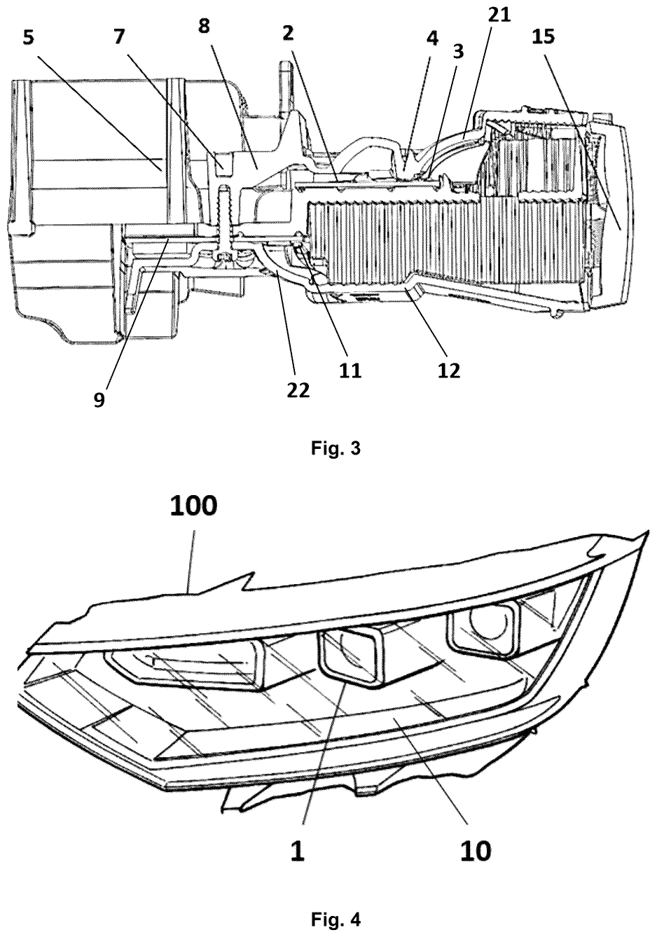

FIG. 4 shows a headlamp 10, which comprises a light module 1 according to the previous figures. This headlamp 10 is installed in an automotive vehicle 100.

What is claimed is:

1. A luminous module for an automotive luminous device,
the luminous module comprising
a first substrate including a first light source configured to emit light;
a first optical element arranged to receive emitted light from first the light source and project the light; and
a heatsink arranged in thermal communication with the first substrate, the heatsink being configured to dissipate heat from the first substrate;
wherein the first optical element includes a main attachment element configured to attach the first optical element to the heatsink without crossing the first substrate; and in that
the first substrate is retained between at least a portion of the first optical element and a portion of the heatsink.

2. The luminous module according to claim 1, wherein a portion of the heatsink forms a portion of a frame for the first substrate.

3. The luminous module according to claim 1, wherein the main attachment element includes a fixing portion and is joined to the rest of the reflector part by means of an arm, the fixing portion being attached to the heatsink.

4. The luminous module according to claim 1, wherein the first optical element is a reflector including a first reflection portion with a first reflection surface that reflects the light rays emitted by the first light source and defines the front of the first reflection surface.

5. The luminous module according to claim 4, wherein an arm is arranged on the first optical element at the rear of the first reflection portion and extending at the rear and away from the first reflection portion.

6. The luminous module according to claim 1, wherein the light source is a solid-state light source.

7. The luminous module according to claim 1, wherein the main attachment element has a triangular shape.

8. The luminous module according to claim 1, wherein the main attachment element is located between two fins of the heatsink.

9. The luminous module according to claim 1, further comprising
a second substrate including a second light source configured to emit light;
a second optical element arranged to receive emitted light from the second light source and project the light;
the main attachment element is arranged to further attach the first optical element to the second optical element without being in the path of rays emitted by the second light source and deviated by the second optical element.

10. The luminous module according to claim 9, wherein the second optical element is a reflector including a second reflection portion with a second reflection surface that reflects the light rays emitted by the second light source and defines the front of the second reflection surface.

11. The luminous module according to claim 10, wherein an arm extends such that it is in a longitudinal direction at the level of the rear of the second reflection portion, such that a fixing portion is attached to the second optical element at the rear of the second reflection portion.

12. The luminous module according to claim 11, wherein the second optical element is arranged such that the second reflection portion is at least partially offset at the rear compared to the first reflection portion.

13. The luminous module according to claim 12, further comprising at least one auxiliary attachment element configured to attach the first optical element with the second optical element, retaining the heatsink, the first substrate and the second substrate between a portion of the first optical element and a portion of the second optical element.

14. A headlamp comprising a luminous module, wherein the luminous module includes a first substrate including a first light source configured to emit light, a first optical element arranged to receive emitted light from first the light source and project the light, and a heatsink arranged in thermal communication with the first substrate, the heatsink being configured to dissipate heat from the first substrate, wherein the first optical element includes a main attachment element configured to attach the first optical element to the heatsink without crossing the first substrate, and in that the first substrate is retained between at least a portion of the first optical element and a portion of the heatsink.

15. The headlamp according to claim 14, wherein a second substrate includes light emitting diodes configured to provide a matrix beam functionality.
